(19) United States
(12) Patent Application Publication
(10) Pub. No.: US 2019/0237984 A1
(43) Pub. Date: Aug. 1, 2019

(54) SOLAR POWERED FAN

(71) Applicant: Deon Dorvil, St. Joseph, MO (US)

(72) Inventor: Deon Dorvil, St. Joseph, MO (US)

(21) Appl. No.: 15/885,833

(22) Filed: Feb. 1, 2018

(51) Int. Cl. H02J 7/00; F04D 25/06; H02J 7/02; H02S 99/00

(52) U.S. Cl. CPC H02J 7/0068; F04D 25/0673; F04D 25/08; H02J 7/0047; H02S 99/00; H02J 7/025

(57) ABSTRACT

A solar powered fan, including a body, a fan rotatably disposed within and attached to the body, and a solar panel disposed on a surface of the body and connected to the fan to provide power to the fan, such that the fan rotates when the solar panel receives energy from the Sun.

### BACKGROUND

### 1. Field

The present general inventive concept relates generally to a fan, and more particularly, to a solar powered fan.

### 2. Description of the Related Art

When having fun in the sun, sweat is unavoidable as the heat beats down on the skin. Having a mobile fan would be great, but unfortunately, most of them require an outlet for the cord to be plugged in to or if its battery operated, may not provide a strong motor to distribute a fresh breeze.

Therefore, there is a need for a battery-operated fan that is solar-powered.

### SUMMARY

The present general inventive concept provides a solar powered fan.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a solar powered fan, including a body, a fan rotatably disposed within and attached to the body, and a solar panel disposed on a surface of the body and connected to the fan to provide power to the fan, such that the fan rotates when the solar panel receives energy from the Sun.

The solar powered fan may further include a battery to provide power to the fan.

The solar panel may charge the battery.

The body may include at least one charging indicator to indicate whether the battery is being charged via at least one of the solar panel and a power cord jack connected to the battery.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top angled view of a front portion of a solar powered fan, according to an exemplary embodiment of the present general inventive concept; and

FIG. 2 illustrates a top angled view of a rear portion of a solar powered fan, according to an exemplary embodiment of the present general inventive concept,

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

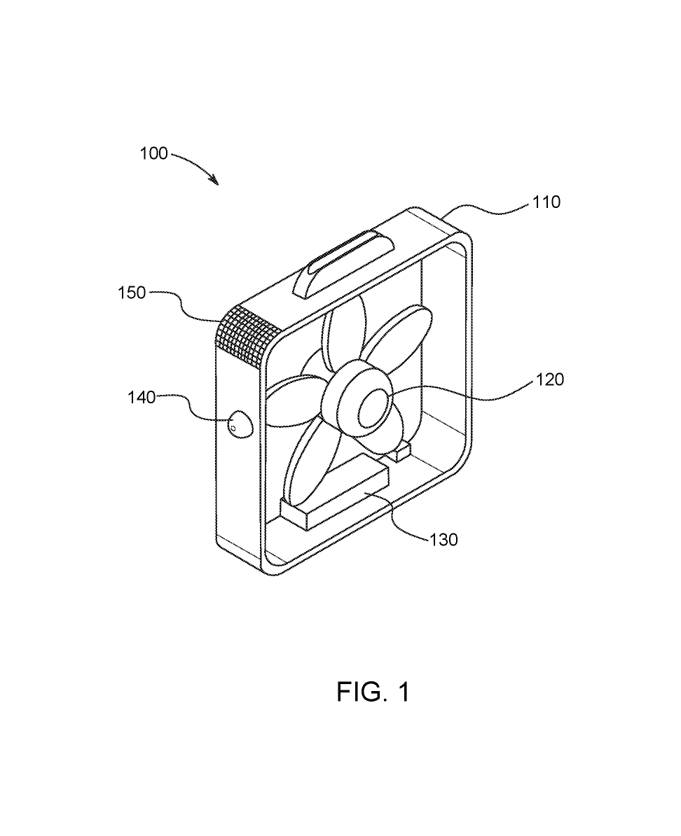

FIG. 1 illustrates a top angled view of a front portion of a solar powered fan 100, according to an exemplary embodiment of the present general inventive concept.

The solar powered fan 100 may include a body 110, a fan 120, a battery 130, a switch 140, and a solar panel 150.

The solar powered fan 100 may be constructed from plastic, wood, metal, rubber, silicone, glass, or any other material known to one of ordinary skill in the art.

The fan 120 may be disposed within the body 110, and may have a plurality of blades to provide a cooling sensation when the fan 120 rotates in a direction on a vertical axis, thereby propelling air in a direction perpendicular to the rotation direction of the fan 120.

The fan 120 may have a motor therein to allow the fan 120 to be mechanically rotated when connected to the battery 130.

The battery 130 may provide power to the fan 120, such that the fan 120 may rotate when the battery 130 maintains at least a small charge.

The switch 140 may be disposed on a surface of the body 110, and may be connected to the battery 130 to provide power to the fan 120 when the switch 140 is turned on.

The switch 140 may be a rotatable switch, a button, or a touch screen, but is not limited thereto.

The switch 140 may be rotated to turn the fan 120 on. More specifically, the switch 140 may be rotated to allow the battery 130 to provide power to the fan 120 such that the fan 120 may rotate. The further the switch 140 is rotated, the faster the fan 120 may correspondingly rotate.

The solar panel 150 may be disposed on any surface of the body 150, may have any size and shape, and may be connected to at least one of the battery 130 and the fan 120. More specifically, when the solar panel 150 is exposed to the Sun, the solar panel 150 may harness energy from the Sun to provide power to the fan 120 to cause the fan 120 to rotate. As such, the fan 120 may rotate even if the battery 130 is not charged.

Alternatively, the when the solar panel 150 is exposed to the Sun, the solar panel 150 may harness energy from the Sun to charge the battery 130.

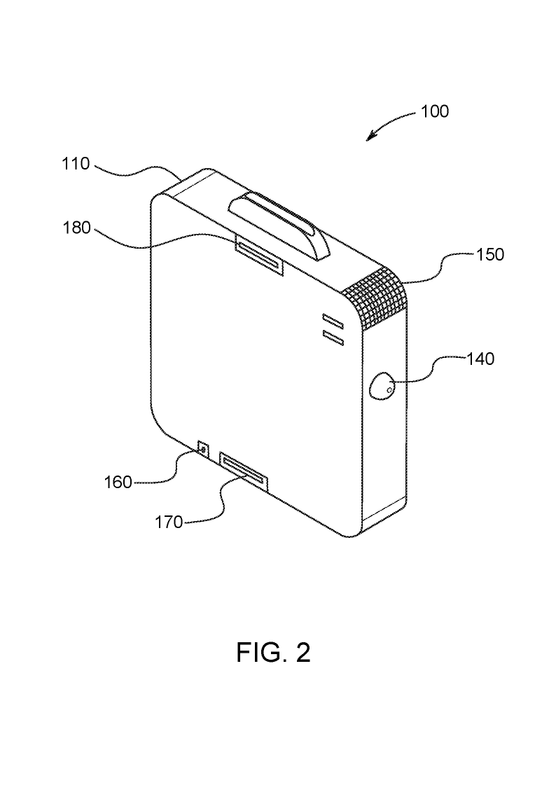

FIG. 2 illustrates a top angled view of a rear portion of the solar powered fan 100, according to an exemplary embodiment of the present general inventive concept.

The solar powered fan 100 may include, on a rear surface thereof, a power cord jack 160, first a charging indicator 170, and a second charging indicator 180

The power cord jack 160 may be connected to the battery 130, such that the battery 30 may be charged when the power cord jack 160 is connected to a electrical power outlet via a power cord.

The first charging indicator 170 may indicate that the battery 130 is being charged by a power cord via the power cord jack 160. More specifically, when the battery 130 is being charged via the power cord jack 160, a red light may indicate that the battery 130 has a low charge, a yellow light may indicate that the battery 130 is charging, and a green light may indicate that the battery 130 is fully charged. However, the indicator lights are not limited to these colors, and may be either solid or blinking lights. Alternatively, the first charging indicator 170 may be a screen that outputs numbers regarding an amount of charge retained by the battery 130.

The second charging indicator 170 may indicate that the battery 130 is being charged via the solar panel 150. More specifically, when the battery 130 is being charged via the solar panel 150, a red light may indicate that the battery 130 has a low charge, a yellow light may indicate that the battery 130 is charging, and a green light may indicate that the battery 130 is fully charged. However, the indicator lights are not limited to these colors, and may be either solid or blinking lights. Alternatively, the second charging indicator 180 may be a screen that outputs numbers regarding an amount of charge retained by the battery 130.

Although FIG. 2 illustrates separate first and second charging indicators 170 and 180, respectively, the present general inventive concept may include a single charging indicator, or multiple charging indicators, disposed anywhere on the body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A solar powered fan, comprising:
a body;
a fan rotatably disposed within and attached to the body; and
a solar panel disposed on a surface of the body and connected to the fan to provide power to the fan, such that the fan rotates when the solar panel receives energy from the Sun.

2. The solar powered fan of claim 1, further comprising:
a battery to provide power to the fan.

3. The solar powered fan of claim 2, wherein the solar panel charges the battery.

4. The solar powered fan of claim 1, wherein the body comprises:
at least one charging indicator to indicate whether the battery is being charged via at least one of the solar panel and a power cord jack connected to the battery.
